(19) United States
(12) Patent Application Publication
(10) Pub. No.: US 2015/0287188 A1
(43) Pub. Date: Oct. 8, 2015

(54) ORGAN-SPECIFIC IMAGE DISPLAY

(71) Applicant: Algotec Systems Ltd., Rochester, NY (US)

(72) Inventors: Tiferet T. Gazit, Tel-Aviv (IL); Uri U. Einav, Yuvalim (IL); Ron R. Grosberg, Ramat Gan (IL); Reuven R. Shreiber, Haifa (IL); Guy E. Engelhard, Kiryat Ono (IL)

(21) Appl. No.: 14/666,386

(22) Filed: Mar. 24, 2015

Related U.S. Application Data
(60) Provisional application No. 61/974,077, filed on Apr. 2, 2014.

(51) Int. Cl. G06T 7/00

(52) U.S. Cl. CPC G06T 7/0012; G06T 2207/10104; G06T 2207/10081; G06T 2207/30004

(57) ABSTRACT

A method and system which displays a single image after a plurality of windows have been applied to image data according to one or more organ masks. The method is accomplished by collecting a radiological scan from an imaging device to form image data; obtaining an anatomically significant mask for said image data; determining a portion of said image data as background; applying a plurality of windows to said image data determined according to said anatomically significant mask and according to said background to determine display values of said image data; and generating a generated display image from said display values.

### CROSS REFERENCE TO RELATED APPLICATIONS

This patent application claims priority to Provisional U.S. Ser. No. 61/974,077 filed on Apr. 2, 2014 entitled ORGAN-SPECIFIC IMAGE DISPLAY to Gazit et al., incorporated herein by reference in its entirety.

### FIELD OF THE INVENTION

The present invention, in at least some aspects, relates to organ-specific image display, and in particular, to an image display which features a plurality of windows determined according to one or more organ masks.

### BACKGROUND OF THE INVENTION

Medical-imaging data sets such as two-dimensional X-ray images and three dimensional CT (computerized tomography), MRI (magnetic resonance imaging) and PET (positron emission tomography) scans are characterized by a high dynamic range of pixel values, which must be reduced for the purpose of display or printing. For example, CT scanners typically generate 12 bit representations of the intensity values of image pixels, in Hounsfield Units (HU), which are a measure of radiodensity of the underlying material that was scanned. The display (for example a computer monitor or mobile device screen), on the other hand, is typically capable of handling only 8 bit gray levels. The process of reducing the 12 bits of data to 8 bits for display purposes is typically done via a process of windowing. The windowing process maps a range (the “window”) of scanner pixel values to a gray-scale ramp or a color palette, described herein generally as “display values”.

In the following, the input high dynamic range values generated by the imaging device (scanner) are described as scanner values, while the outputted image data displayed to the user is given in display values.

The term windowing can be applied to various types of imaging, each of which has its own scale of image pixel units over a large range, to which a map from a window of that range into a gray-scale or color palette value system is generated. For example, in CT images the image pixels are given in Hounsfield Units, while for MRI images, the units in which the pixels are given are proportional to the concentration of hydrogen atoms in a voxel of space modified by various parameters such as T1 or T2 relaxation times.

To continue with the CT example, according to the Hounsfield Unit definition, the radiodensity of distilled water at standard pressure and temperature (STP) is defined as zero Hounsfield units, while the radiodensity of air at STP is defined as −1000 HU. Soft tissues have HU values around and slightly above 0, while bones typically have HU values in excess of 400. Because it is full of air, lung tissue typically has HU values between approximately −500 and −1000. For all these tissue types, detailed structures within the organs, such as blood vessels, bone marrow, bile ducts, and so on, may have different ranges of HU values. In addition, pathologies such as lesions, infections, calcifications, blood clots, etc. may be expressed visually by either subtle or large differences between the healthy tissue and the affected area. Therefore, the “window” of HU values of the image, according to which the image is displayed, is selected for optimized viewing of an organ, according to a range of HU values within which pixels of that organ fall, such that the screen/display pixel value assigned to each pixel is determined according to the windowing. The optimal window is selected so as to accentuate differences between healthy tissue and possible anomalies (while displaying the full range needed to cover the intensity values present in this organ or tissue type), to ensure anomalies are visually detected by the radiologist.

Typically, HU values below the window are mapped to black and HU values above the window are mapped to white. The values inside the window are optionally linearly mapped from black to white where the lowest value in the window is mapped to black and the highest to white. Non-linear mapping may also optionally be used; in fact, any function from scanner values to display values is supported by DICOM and can be encoded as a table mapping each scanner value to display value. For example, CT images of the brain are commonly viewed with a window extending from 0 HU to 80 HU. HU values below 0 are assigned black color while HU values greater than 80 are assigned a color of white. The intervening HU values are evenly spaced between the black and white colors.

For imaging modalities other than CT, similar considerations are important when selecting a window range, aiming to include all pixel values present within the organ while selecting a narrow enough window that pixels with even subtly different values will appear different in the gray-scale display, to allow visual detection of subtle anomalies.

Various methods are used to characterize the windowing operation, one of which is providing the windowing level (or center) and width of the window. For instance, under best practices known in the art, for CT images of the brain, the window level is 40 HU, while the width is 80 HU. This type of windowing operation is a linear map from the range of 0-80 HU to the display range, although optionally non-linear maps may be used.

One advantage of using predefined windowing values rather than either manually or automatically generating the windowing ranges on a per-study, per-reading basis is that radiologists grow used to looking at a certain organ or tissue type with a given window, and their trained eye can then immediately pick up on subtle differences in intensity over a diffuse region simply by noticing that the tissue under observation is slightly brighter or darker than they are used to seeing it in this windowing. They can furthermore immediately assess the degree of contrast agent enhancement a tissue is subjected to, when relevant, from the average grayscale value of its pixels in the standard windowing they always use.

In CT images, predefined sets of windowing values, for example lung, bone, abdomen, brain, liver, and IAC (internal auditory canal) windows, enable optimized viewing of specific features in the image. Such windowing values are well known in the art, as described above. However as discussed above, there is no single set of windowing values which are suitable for all tissues.

During the reading process, therefore, the radiologist usually uses several different windows to obtain optimized viewing. For example, when interpreting a chest study, a radiologist may typically use a lung window, a body window and a bone window. However, all of the images need to be viewed separately with each of these windows, so that the radiologist needs to view the same set of images three times, once for each window, each time looking for anomalies in the corresponding tissue types.

With regard to the example of chest images, the lungs need to be viewed using lung windowing, while the heart and aorta are viewed using abdomen windowing, and the sternum, spine and ribs need to be examined using bone windowing. Since all of these organs co-exist in the same set of images, the radiologist needs to examine this set of images using three different windows. Effectively, the radiologist must view the images multiple times, one time for each window that is applied to the images. The appearance of the images changes for each window that is applied.

In the past, several non-linear and other filters were used in an attempt to incorporate all of the required windowing operations into a single set and thus reduce the time needed for the reading. These methods are based on the field of high dynamic range imaging (HDRI) and attempt to enhance the contrast of the image. These attempts are not clinically employed mainly because the output is different from the type of images with which radiologists are familiar, and because they prevent the radiologists from visually comparing regions that belong to a similar organ/tissue type in order to detect anomalies.

### SUMMARY OF THE INVENTION

The background art either requires radiologists to view the same image more than once in order to view organs having different image windows, or alternatively to view a filtered image which has a different appearance from single window images. The background art does not provide a solution in which the radiologist views a single image to which a plurality of windows has been applied, which incorporates anatomical knowledge to determine how the windows are applied, and which ensures that each anatomical region is viewed with the standard windowing with which radiologists are most experienced.

By contrast, the present invention overcomes the drawbacks of the background art by providing a method and system which displays a single two-dimensional image which features a plurality of organ windows, each of which is applied to a different region or regions of the image to determine the appearance of that region in the display, while maintaining the expected appearance of each image region for the radiologist.

The present invention, in various embodiments, has advantages due to the use of anatomical information. Without wishing to be limited by a closed list, these advantages include displaying images with local windowing parameters that are familiar in appearance to radiologists; unlike filtering methods, the methods of the present invention do not risk hiding anomalies that are expressed through slightly brighter or darker intensities within a given organ; and the methods of the present invention allow non-adjacent regions that belong to the same tissue type to remain visually comparable, including in cases where their intensities are very different due to anomalies.

According to at least one embodiment, there is provided a method and system which displays a single image after a plurality of windows have been applied to image data according to one or more organ masks. The method is accomplished by collecting a radiological scan from an imaging device to form image data; obtaining an anatomically significant mask for said image data; determining a portion of said image data as background; applying a plurality of windows to said image data determined according to said anatomically significant mask and according to said background to determine display values of said image data; and generating a generated display image from said display values.

### BRIEF DESCRIPTION OF THE DRAWINGS

FIGS. 1A and 1B show exemplary methods according to at least some embodiments of the present invention for creating a generated display image as described herein.

FIG. 2 shows an exemplary system according to at least some embodiments of the present invention.

FIGS. 3A-3C show some exemplary, non-limiting screenshots of screens generated according to at least some embodiments of the present invention.

### DESCRIPTION OF PREFERRED EMBODIMENTS

As noted above, the present invention overcomes the drawbacks of the background art by providing a method and system which displays a single two-dimensional image which features a plurality of organ windows, each of which is applied to a different region or regions of the image to determine the appearance of that region in the display, while maintaining the expected appearance of each image region for the radiologist.

Optionally, according to at least some embodiments, a background windowing is applied to all image regions that do not lie within one of the predetermined region or regions in the image which corresponds to a particular organ or organs. Such a background window may optionally correspond to an abdominal window for example, or any other type of background windowing.

By “window” or “windowing parameters” it is meant any mapping of the image data scanner values to display values. The mapping may be linear or non-linear, or it may simply consist of a lookup table listing a display value for each possible scanner value. Optionally, linear mapping may comprise piecewise linear mapping, for example for mapping of CT values as is known in the art. As is known in the art, CT windows are typically piecewise-linear mappings with constant values below and above a given range, and a linear mapping within the given range that begins at the value assigned to the lowest values and ends at the value assigned to the highest values.

The mapping may optionally be broadened further to include general filtering operations, by allowing any mapping of the image data scanner values within a neighborhood to display values. For example, within one specific organ, the display could optionally be smoothed by mapping each small neighborhood of scanner values to a display value, using a mapping function that computes the average of the neighborhood scanner values and then applies a conversion function from scanner to display values according to the calculated average. Optionally all of the windows are applied simultaneously, whether for three dimensional or two dimensional image data.

For the three-dimensional imaging modalities described herein, an image may optionally feature three-dimensional data or alternatively may be a two-dimensional “slice” of a three-dimensional set of image data, which may be cut in any orientation relative to the original three-dimensional set of image data. For both the two- and three-dimensional imaging modalities described herein, the image displayed on screen may include greater or fewer pixels than the original imaging data and may cover either the entire original image or slice, or a region of the image or slice, optionally depending on such factors as, for example, the size of the display, and the current zoom and pan settings selected for the display (see below for optional embodiments related to interpolation and methods of the present invention which are applicable in such situations, as zoom and pan settings will often require interpolation of the images).

As defined herein, the original set of input medical images (whether a single two dimensional scan or a three dimensional scan) is defined as the “radiological scan”, while two dimensional output display image (which is ultimately displayed to the radiologist, and which may optionally for example be a grayscale image) is defined as the “generated display image”.

Also as used herein, pixels and voxels are mentioned interchangeably.

The windowing operation (or the application of a window) as described herein is a map between a scanner value (e.g. a HU value) and a display value. The map is typically linear but may also be non-linear; any function from a scanner value to a display value is acceptable and is also supported by DICOM. As an optional example, the linear windowing mapping for HU to gray level values is given by a center (HU_{c}) and a width (HU_{w}) and is defined as:

$$G ( HU ) = Min ( 1 , Max ( 0 , \frac{HU - ( {HU}_{c} - \frac{{HU}_{w}}{2} )}{{HU}_{w}} ) )$$

where G(HU) is the gray level value between 0 and 1 where 0 is black and 1 is white.

While the present invention is not limited to CT images and hence is also not limited to HU, it is recognized that the HU scale of CT and X-Ray images affords an additional advantage over the other modalities since it is standardized across the various vendors of imaging devices.

Still, also as noted above, it is possible to determine effective windows for different organs imaged with different types of imaging technologies in order to provide the best display of that organ to the radiologist. However, as discussed above, there is no single window that displays the range of tissue types well for any of these different types of imaging technologies. The radiologist that views an MR image, for example, is faced with two options: either to use some sort of automatic windowing where the system detects the range of values visible on the screen and selects a center and width automatically to get the best contrast, or resort to manual modification of the center and width of the image until the features of the image can be satisfactorily distinguished.

According to at least some embodiments, masks are input for one or more organs in a radiological scan (or alternatively one or more regions within an organ), such that each mask defines which pixels (or voxels) belong to it. To generate the generated display image, the set of pixels belonging to each mask is windowed according to the appropriate window parameters, preferably as is defined in the art if available or alternatively determined as described above, optionally with input from the user or from preconfigured stored user preferences. Each such windowing provides the best display of the corresponding organ for which the window was selected.

According to at least some embodiments of the present invention, windowing for imaging technologies that do not use standard HU values may optionally be performed with automatic selection of the appropriate window for each organ mask as described above, or alternatively by allowing the radiologist to select windowing parameters (such as, for example, a center and width) for each region separately (or some combination thereof). It is understood that for these imaging technologies, a standardized windowing cannot be used, as standardized windows are not available for these imaging technologies. Per-organ selection of windows (either automatic or manual), however, can still achieve the important purpose of allowing the radiologist to view all organs within the image in a single viewing on the image, eliminating the need to view the same set of images multiple times, each time with a different windowing setting.

Optionally, the generated display image is generated by scanning pixel by pixel and determining the display value for each pixel based on the pixel's location (i.e.—according to the organ to which it belongs) and the windowing parameters associated with that organ; alternatively, a plurality of windowed images is obtained and is then recombined by choosing which pixel will be taken from which image based on the pixel's location.

In either case, a single generated display image is formed according to the previously input masks. The generated display image still has the same scanner (for example, HU) value at each pixel as the original scanned image data, but the screen/display pixel value assigned to each pixel is determined according to the windowing.

In most cases each voxel belongs to only one mask. Situations in which a voxel belongs to more than one mask are optionally and preferably resolved when rendering the image to form the generated display image and selecting which windowing operation to apply for pixels falling in those voxels. The resolution may optionally be performed in various ways that are known in the art, for example and without limitation by sorting the window maps in order of decreasing importance or by other variations on such sorting.

As a simple example, the image may feature an organ and a background to that organ. The organ is represented by a set of pixels of the image given by an input mask, such that a specific windowing associated with the organ is applied only to the pixels that are located within the organ mask. In this example, one windowing is applied to all pixels located within the organ mask, while another windowing is applied to all pixels in the background (i.e.—pixels not located in the organ mask). In this example, there is one mask but two windowings. The background may optionally itself contain one or more additional organs, but in this example the additional organs are not given windowings different from the background windowing. Organs may be given the same windowing as the background for several reasons, including one or more of the following: there is no input mask available for the additional organs; the additional organs are not of interest to the radiologist; and/or the group of scanner values found within the additional organs and within the background are similar, so that they may all be viewed with a single windowing.

As another example, if there are two organs shown in an image, a first organ and a second organ, each having a corresponding set of pixels of the image represented by an input mask, then a specific windowing associated with the first organ is applied only to the pixels that are located in the first organ mask, and a specific windowing associated with the second organ is applied only to the pixels that are located in the second organ mask. Optionally, a background windowing is applied to all pixels that are located outside of both the first and the second organ masks as for the background described above.

As a non-limiting example of the above method, if a lung mask and a bone mask are provided, then a lung window may be assigned for the lung voxels (pixels) in the rendered image, a bone window may be assigned to the bone voxels of the image, and an abdomen window (or other background window) may optionally be assigned for anything that remains.

In the general case, optionally there are n organ masks but n+1 windowings. In a sense, instead of mapping only intensity values (optionally within a neighborhood) to display values, as the background art does, this method maps intensity values coupled with pixel locations to display values.

The input masks may optionally be determined according to any suitable method. For example, the location or boundary may optionally be determined according to segmentation as is known in the art. Various segmentation methods are known, including manual, semi-automatic and automatic methods. Non-limiting examples of such methods are described in U.S. Pat. No. 8,306,305 (Porat) issued on Nov. 6, 2012; and U.S. Pat. No. 8,494,240 (Milstein) issued on Jul. 23, 2013; all of which are incorporated by reference as if fully set forth herein. Other examples of segmentation methods are known in the art and could easily be selected by one of ordinary skill in the art.

Another optional embodiment for determining the organ masks employs an imaging device which is able to obtain an image that already contains the determination of the location of a plurality of organs. As a non-limiting example, a dual or spectral energy CT already features an image for which the generation of the masks is trivial and guaranteed to be accurate. A bone mask for example can be generated from a calcium-iodine map in a dual energy scanner. Other such masks for different body parts are also possible, such as blood vessels containing iodinated contrast material for example. However, other methods may be used to obtain other organ masks not determined or assisted by the imaging device.

According to at least some embodiments, the radiologist sets the necessary number and parameters of windows to match the various masks and background. Additionally or alternatively, an automatic workflow can be defined whereby whenever the masks are available, a windowing operation on the image data is performed automatically, assigning display values to scanner values for the pixels of the image based on the provided masks and preconfigured windowing parameters.

When each generated display image is prepared in the manner described above, the radiologist can view the entire set of images once using this hybrid windowing technique instead of reviewing the images multiple times with a different windowing assignment each time. Therefore, considerable time savings is introduced into the reading process while enabling the radiologist to view the various parts of the generated display image using familiar and/or optimal values.

Optionally, according to at least some embodiments, the window applied to each mask may be adjusted by the radiologist. For example, the radiologist may optionally change the window parameters and/or may select a different window than the currently applied window, for example in order to view a certain aspect of the anatomy (or pathology) more easily. Therefore, optionally and preferably, the windows are not fixed in advance in terms of which window parameters are applied to which mask, or at least the windows are adjustable by the radiologist.

According to at least some embodiments of the present invention, in order to generate the pixels of the display image, an interpolation process on the pixels of the radiological scan needs to be performed. Such interpolation may optionally be performed after the window is applied to pixels defined as belonging to a particular organ or alternatively before the window is applied. Indeed, optionally the various stages described herein (determining the organ mask(s), performing interpolation, and applying windowing) may be performed in any order. Interpolation may also be performed a plurality of times as described in greater detail below.

On a general level, when displaying an image as described herein, interpolation is often required, due to resampling of the image. Resampling means that there is no longer a 1-to-1 relationship between the initial pixels of the scanner image data being analyzed and the pixels being displayed. The value of each pixel needs to be determined for the new grid of pixels, whether windowing is performed before or after interpolation. Interpolation can for example be performed in the close neighborhood of the pixel to determine the value. Various techniques are known in the art for interpolation and are described in greater detail below.

According to at least some embodiments of the present invention, interpolation is optionally performed after each window is applied to the organ mask(s) (and the background, if present). This method is known as a “pre-interpolated transfer function (windowing operation)”. Various methods are described below for performing such a function.

If interpolation is performed before each window is applied to the organ mask, then the organ mask itself needs to be interpolated in order for the window to be correctly applied to the proper pixels associated with the organ. This method is known as “a post-interpolation transfer function (windowing operation)” and is also described in greater detail below.

Other applications of the system and method of the present invention may optionally be performed as described herein. In modalities such as MRI and US, the image intensity values do not have a well-defined meaning for a variety of reasons. For example and without limitation, there is no HU scale for MRI. Each scanner and each protocol is different. For instance in some protocols fat is enhanced and appears with high intensity values while in another MRI protocol fat can be chosen to be suppressed and appears dark. Also, the actual value is dependent on the scanner manufacturer and even on the specific scanner. Nonetheless, by application of the described method, it will be possible to automatically set window levels optimized for each provided organ mask such as kidneys, bone, liver, etc. according to the particular image received from the device, thus improving the overall appearance of the displayed image. Such automatic window parameters may be constructed, for example, by generating a linear mapping from a set of scanner values to a set of display values such that the center of the window is given by the mean of the scanner values of the voxels within each mask and the width of the window is determined according to the standard deviation of these scanner values.

Without wishing to be limited by a closed list, among the differences between the proposed method according to various embodiments of the present invention and the previously described HDR methods is that in the HDR and other filter type methods, the filtering is applied to the entire image in order to locally enhance the contrast of the image, and the resulting parts of the image do not have the characteristics radiologists expect to see. By contrast, as described for the system and method herein, each mask is given its own windowing operation, but these are optionally standard windowing parameters using the familiar mappings locally in each region (alternatively, as noted above, the radiologist may choose to make one or more changes to the windowing levels and widths). Therefore, locally for each mask (organ), the features of the image appear as what radiologists expect to see.

In addition, filter based methods suffer from a number of further drawbacks. Such methods are based only on the values seen in the current image and not on anatomical prior knowledge, and hence risk selecting windowing values that hide anomalies that are expressed through unusually bright or dark intensities within a given organ. Additionally, regions that belong to a similar organ/tissue type but are not physically adjacent become visually incomparable, interfering with the radiologist's ability to visually detect anomalies.

Such problems are overcome by the system and method as described herein. For example, in a study in which the left and right lungs have different mean intensities due to emphysema, infection, or other diffuse pathology, filter-based methods will render each lung with a different windowing, so that their actual difference in densities is not visually apparent to the radiologist, whereas the presently described method will render both lungs with the same, standard lung window, thus ensuring that the difference in density between the two lungs remains visually apparent, and that the two lungs remain visually comparable. Similarly, if the left and right kidneys contain different amounts of contrast agent, perhaps because of blood flow problems in one of the kidneys, by giving both kidneys the same windowing parameters despite their physical distance, the method as described herein allows their intensities to be visually compared and lowers the risk of the radiologist missing the anomaly.

Similar drawbacks found in filter based methods may also be seen in the taught method of U.S. Pat. No. 8,406,493 (Choi) issued Mar. 6, 2013. This method also does not use any anatomical knowledge to determine how best to display an image to a radiologist but instead relies upon a simple thresholding method. As noted above, such thresholding methods have many drawbacks.

Other methods with similar drawbacks are described in “A biologically-based algorithm for companding computerized tomography (CT) images” by Cohen-Duwek et al, Computers in Biology and Medicine, vol 41 (2011), pages 367-379. The described methods do not assign windows to specific region(s) of the image according to anatomical knowledge, but rather again focus on manipulating the entire image as a whole, without specific anatomical knowledge. For example, one taught method compresses and expands (compands) the HDR CT image into a single, low dynamic range image before performing further manipulations on that single image.

As described herein, the term “computer” may optionally relate to any device with a processor that is capable of performing computations, including but not limited to a desktop computer, a laptop computer, a server, a mainframe, a cellular telephone, a mobile electronic device, a PDA (personal digital assistant), a smartphone, a thin client or any other such computational device.

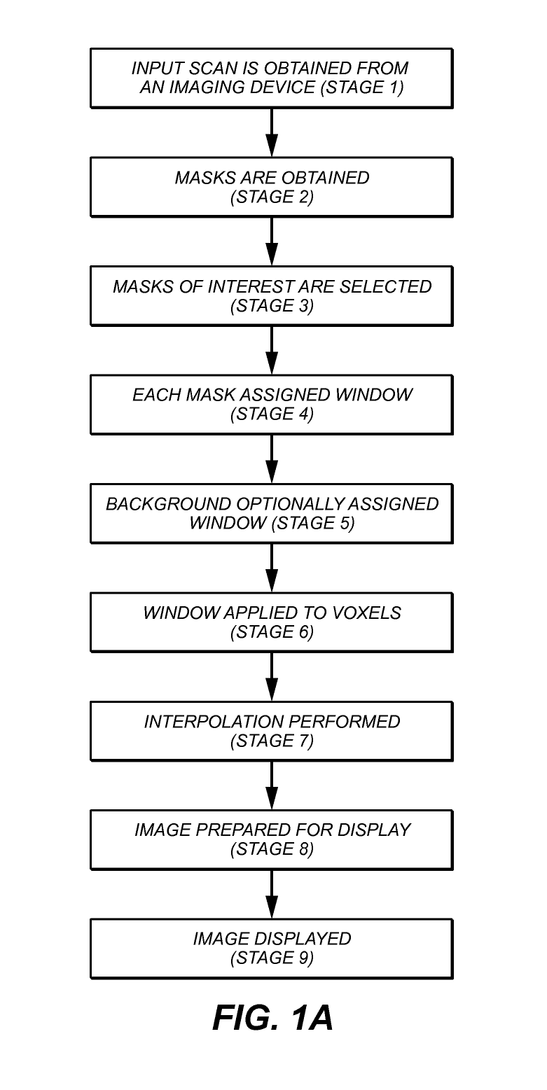

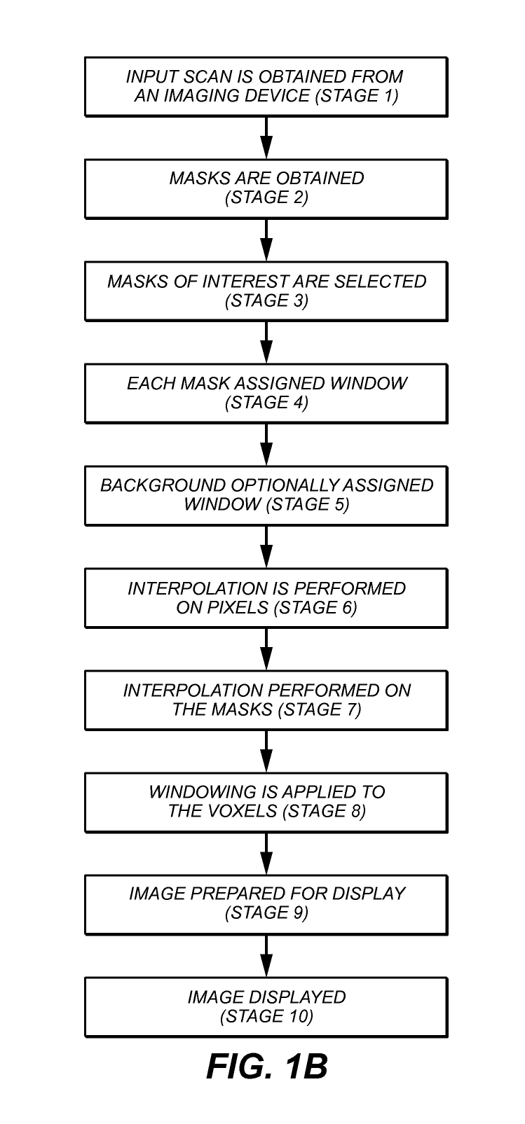

Turning now to the drawings, FIGS. 1A-1B show an exemplary method according to at least some embodiments of the present invention for creating a generated display image as described herein. FIG. 1A shows an example in which interpolation is performed after windowing, while FIG. 1B shows an example in which interpolation is performed before windowing.

As shown in FIG. 1A, in stage 1, an input scan is obtained from an imaging device. If the input scan is three dimensional, optionally at least one two-dimensional slice image is created from the three dimensional data. Optionally one or more other processes may be performed on the two dimensional image (or on a two dimensional obtained image) to form image data to be analyzed. Alternatively, the three dimensional data from the input scan may be analyzed in the below stages, although the image data does need to be converted to two-dimensional image data before the display image is generated.

In stage 2, one or more input masks are obtained, representing one or more organs (or alternatively one or more regions within an organ) within the image data. The organ masks may optionally be generated automatically, manually or semi-automatically, for example through segmentation, which may happen on the server, on the client, within the scanner itself, or in a separate segmentation engine sitting on a different device, such as a dedicated workstation. Segmentation may optionally be performed as described previously. Additionally or alternatively, some imaging devices already provide one or more masks for specific organs or tissues, such as bone for example, as previously described. Additionally or alternatively, the input masks may be provided as input from a different source.

In stage 3, the organ mask(s) of interest are selected from among the set obtained in stage 2. The selection may be done manually by the radiologist, may be hard-coded, may be stored in a configuration file as a user preference, or may be obtained in any other way or combination of ways. For example, a default selection may be hard-coded, with the option for each user to overwrite this selection through the user preferences configuration, and a further option for the user to change the selection in real-time for the current image during the viewing process. It is possible to automatically compute a reasonable selection by finding the set of masks containing a range of scanner values that is significantly different from the range of scanner values found in the background. Optionally all available masks are selected.

In stage 4, each mask selected in stage 3 is assigned windowing parameters to determine its mapping from scanner values to display values (it should be noted that a linear map is not required but may optionally be used). For example, the assignment can be hard-coded (such that, for example, the bone mask is assigned a bone window) when a preset optimal window can be determined (not possible with all scanning modalities); each mask's windowing parameters may be obtained from a configuration file which may store the user's preferences; optimal windowing parameters may be computed from the scanner values contained within the mask (for example, by using the mean and standard deviation of the scanner values to set a window center and width); and/or the user may select the window parameters that each mask is assigned.

In stage 5, optionally, according to at least some embodiments, background windowing parameters are selected, assigned or determined for application to all image regions that do not lie within one of the predetermined region or regions in the image which corresponds to a selected mask. Such a background windowing may optionally correspond to an abdominal window for example, or other background window as appropriate for the image being viewed, or may be determined in any of the ways described for assigning mask windows in stage 4.

Stages 1-5 may optionally be performed in many ways as they provide inputs to the next stages in which the inventive method is described.

In stage 6, the windows are applied to voxels as determined above. In stage 7, optionally interpolation is applied to the windowed image data to create a 2D image that has the number of pixels needed by the display and shows the image region determined by the current zoom, pan, and rotation. Stages 3-7 may alternatively and optionally be switched in order, such that the order of stage 3, stages 4-6 and stage 7 may optionally be changed. FIG. 1B describes another exemplary non-limiting order, in which mask selection/determination is performed, after which interpolation is performed, followed by windowing. On a general level, when displaying an image as described herein there is frequently a need to interpolate over the pixels, as described above. For instance, CT images coming from the imaging modality have 512×512 pixels. However, when displaying such images, the radiologist may wish to zoom in or out of the image and therefore the rendered image has either more or less than 512×512 pixels. If, for example, the screen image is 768×768 pixels, what is usually done is to resample the original image. In this example, every ⅔ of a pixel in the image is resampled. However, resampling means that there is no longer a 1-to-1 relationship between the initial pixels of the scanner image data being analyzed and the pixels being displayed. For the new grid of pixels, the value of each pixel needs to be determined.

One way to handle the issue of determining the display values is to perform interpolation in the close neighborhood of the pixel by using information from the neighboring pixels in some manner in order to decide the value of that pixel. For CT, the pixel values are given in HU units and so for interpolation, a new pixel is created, having some HU value that is given by a function of the neighborhood of this pixel.

Various sampling techniques are known in the art. The simplest is nearest neighbor interpolation, such that the HU value of the resampled pixel is the HU value of its closest neighbor. Other methods such as bi linear interpolation or bi cubic interpolation (as non-limiting examples only) are also known in the art. Bi linear interpolation basically means that the HU value of the pixel is given by linearly interpolating the values of the upper two and lower two neighbors along the x direction, and then linearly interpolating the resulting two values along the y direction. It can be given by the following formula:

HU(x,y)=(┌x┐−x)(┌y┐−y)HU(└x┘,└y┘)+(x−└x┘)(┌y┐−y)HU(┌x┐,└y┘)+(┌x┌−x)(y−└y┘)HU(└x┘,┌y┐)+(x−└x┘)(y−└y┘)HU(┌x┐,┌y┐)

where the values of the HU at the integral positions are taken from the image radiological scan. For 3D data sets the extension of the above to tri-linear interpolation is straightforward. Many additional methods are known in the art and the present invention is not limited by only those mentioned above.

According to at least some embodiments, and as described in FIG. 1A, interpolation is optionally performed after the window is applied to the voxels belonging to the various organ masks (that is, interpolation is not performed according to HU but rather according to the display values after mapping the HU values). This method is known as a “pre-interpolated transfer function”.

In terms of the above described equations, it can be written as follows:

$$G ( x , y ) = ( ⌈ x ⌉ - x ) ( ⌈ y ⌉ - y ) G ( HU ( ⌊ x ⌋ , ⌊ y ⌋ ) ) + ( x - ⌊ x ⌋ ) ( ⌈ y ⌉ - y ) G ( HU ( ⌈ x ⌉ , ⌊ y ⌋ ) ) + ( ⌈ x ⌉ - x ) ( y - ⌊ y ⌋ ) G ( HU ( ( ⌊ x ⌋ , ⌊ y ⌋ ) ) + ( x - ⌊ x ⌋ ) ( y - ⌊ y ⌋ ) G ( HU ( ⌈ x ⌉ , ⌈ y ⌉ ) )$$

In stage 8, a generated display image is prepared for display, for example by optionally adding annotation or other graphical features. In stage 9, the generated image is then displayed to the radiologist or other user.

FIG. 1B shows an example in which interpolation is performed before windowing. Stages 1-5 are optionally performed as for FIG. 1A. In stage 6, interpolation is performed on the pixels (for example, to zoom in or out of part of an image or alternatively to project the 3D volume to a 2D raster of the dimensions of the rendered image).

In stage 7, interpolation is also performed on the masks, in order to determine the display values to be applied to the pixels after interpolation for the reasons described above. This stage features selection of the parameters to be used for that pixel's windowing by interpolating the masks, in addition to deciding the intensity value of pixels (performed in stage 6). The process of interpolating the masks is required since after the interpolation there is no longer a 1-1 correspondence between the pixels being displayed and their association to the masks. It is desired to determine the association of the pixels to the various masks after these pixels were generated by the interpolation method of stage 6. The easiest method to use for the interpolation of the masks is the nearest neighbor approach; however, methods such as voting by the various participating windowing operations, as well as additional methods, are also employed in the literature.

In stage 8, windowing is applied to the voxels according to the interpolated scanner values and the interpolated masks. In stage 9, a generated display image is prepared for display, for example by optionally adding annotation or other graphical features. In stage 10, the generated image is displayed to the radiologist or other user.

Interpolation may optionally be divided into several stages, for example. Interpolation and windowing may optionally be intertwined, with repeated rounds of interpolation and windowing performed. However, as described above, if interpolation is performed before windowing, then interpolation needs to be performed over the masks as well, and also over the background (if present).

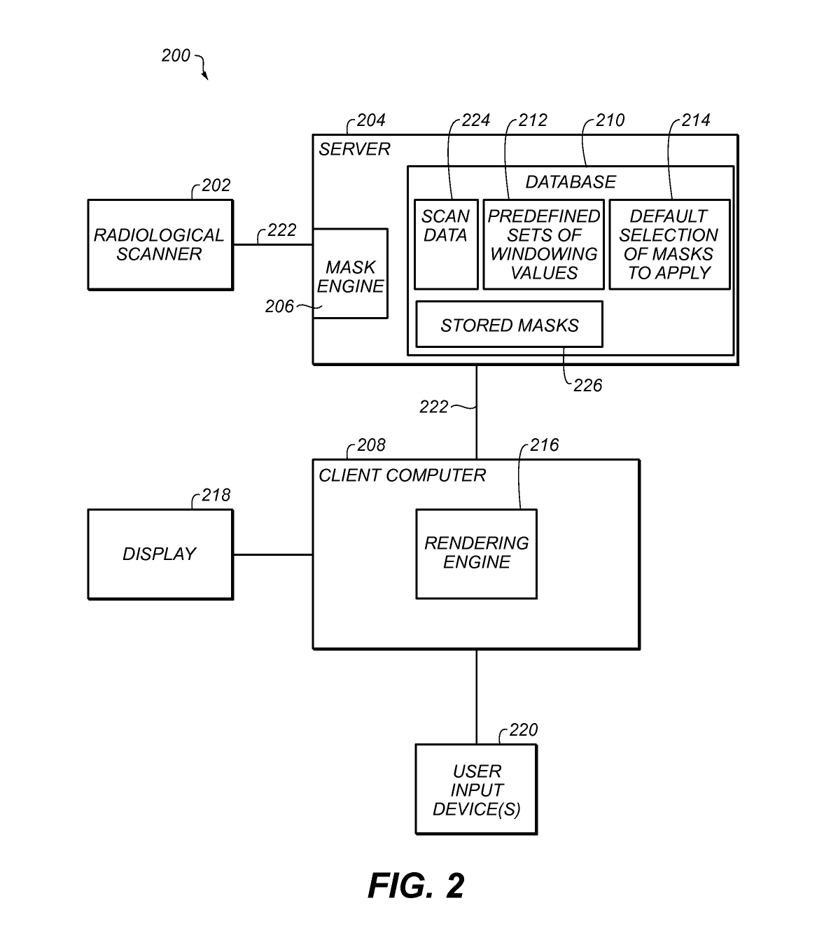

FIG. 2 shows an exemplary system according to at least some embodiments of the present invention. As shown, a system 200 features a radiological scanner 202, which may for example and without wishing to limit ourselves to a closed set optionally feature a PET (positron emission tomography) scanner, a CT (computerized tomography) scanner, or an MRI (magnetic resonance imaging) scanner for obtaining three dimensional image data, or an x-ray scanner or other two dimensional image scanning technology for obtaining two dimensional image data, or an US (ultrasound) scanner for obtaining two- or three-dimensional image data with multiple time frames. Radiological scanner 202 is used to obtain a radiological scan of at least a portion of a subject (not shown). The scan features a plurality of organs of the subject. For example, an abdomen scan can contain lungs, liver, spleen, kidneys, and so forth.

The radiological scan is provided to a server 204. Server 204 may optionally convert the radiological scan data from a three dimensional image to two dimensional image data (for example by obtaining one or more slices of the three dimensional image). Alternatively three dimensional image data may optionally be used directly, or (also optionally) radiological scanner 202 may provide the image data as two dimensional image data.

Server 204 optionally operates a mask engine 206, which analyzes the scan data in order to compute the masks. Optionally and preferably, each mask relates to an organ or tissue. For example, as previously described, the masks could optionally be computed by segmentation.

Segmentation may optionally also be performed at a client 208 (in which case mask engine 206 is preferably located at client 208), and/or may optionally be performed online or offline. Segmentation is preferably performed automatically, but may also optionally be performed semi-automatically or manually. Additionally, the masks may be read in or supplied by an external source, in which case the mask engine is not needed and the masks are stored in the database (see below).

Server 204 also optionally contains a database 210, which preferably receives and stores scan data 224. Database 210 optionally contains various configuration parameters such as which masks (214) to apply by default (which organs should receive windowings different from the background) and the default preset windowing parameters (212) to apply to each mask, as well as to the background, if relevant. Database 210 may also optionally receive and store masks from mask engine 206 or from external sources. These masks are stored in stored masks 226.

Optionally, organ masks (indicating at least the organs of interest) are input or selected through client computer 208, whether provided from database 210, mask engine 206 or any other source. Alternatively the requested masks can be configured in advance and created automatically according to the configuration, whether stored at database 210 or client computer 208. Optionally, configuration settings shown in database 210 could be stored at client computer 208.

Client computer 208 receives at least the scan, and optionally also one or both of masks and configuration settings from server 204. It may also receive user input from the user input device(s) (for example a mouse, keyboard, etc.; 220) as to which scan to display, the zoom, pan, and rotation (if 3D) to display the scan in, and optionally which masks to display and with what windowing parameters. Client computer 208 preferably contains a rendering engine 216 (which could optionally also sit at server 204 or at another separate location (not shown)) which uses all these inputs to create the generated display image. Client computer 208 then displays this image on the display 218, which may be a computer monitor, a mobile device screen, a paper printout, etc.

Rendering engine 216 applies the windows to the image data to form the generated display image, which is displayed to the radiologist through display 218. In this process, pixels relating to each organ (or other anatomical feature) within the image are windowed according to different windowing parameters. Optionally a separate windowing is applied to background pixels. Optionally and preferably, the rendering process occurs in real time, upon request by a radiologist, who may interactively change the rotation, zoom, pan, and windowing parameters for each organ (and the background). In other words, the generated display image features a plurality of windows that were applied to different parts of the generated display image, based on prior anatomical knowledge, rather than applying a single window or filtering process over the entire image to form the generated display image as is known in the art.

Rendering engine 216 also optionally and preferably performs interpolation on the image data, either before windowing is performed or after windowing is performed, or both, as described above.

Server 204, radiological scanner 202 and client computer 208 preferably communicate through a computer network 222, such as the Internet for example. Optionally and alternatively, server 204 and client computer 208 are the same computer or the same plurality of computers (not shown). Also, the components shown in server 204 may optionally be distributed through other computational devices (not shown).

Optionally, client computer 208 is a thin client, web client or the like. In this example, the image would optionally be displayed through software such as a web browser operated by client computer 208, while being generated from another computer such as server 204.

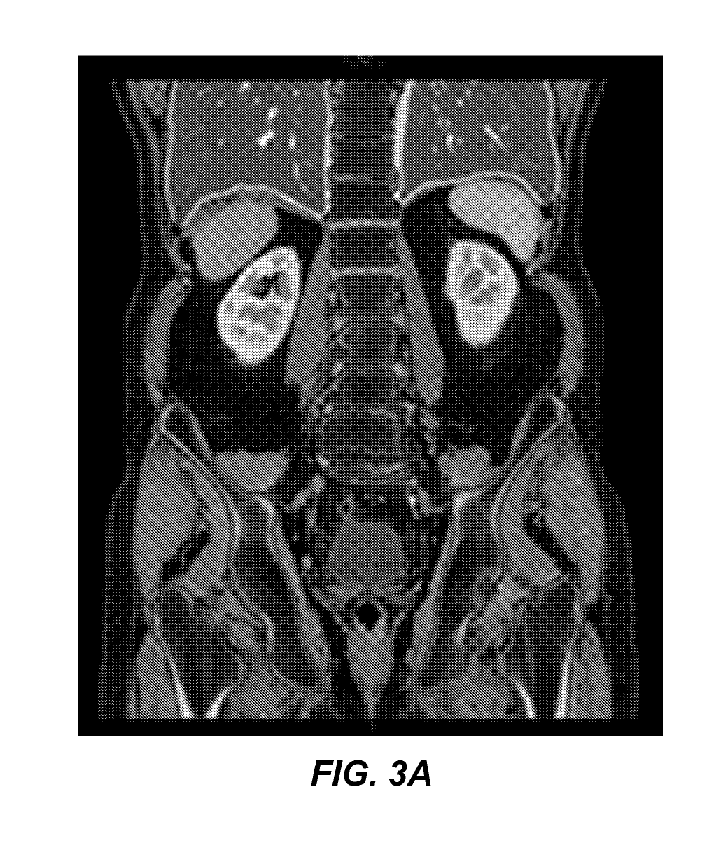

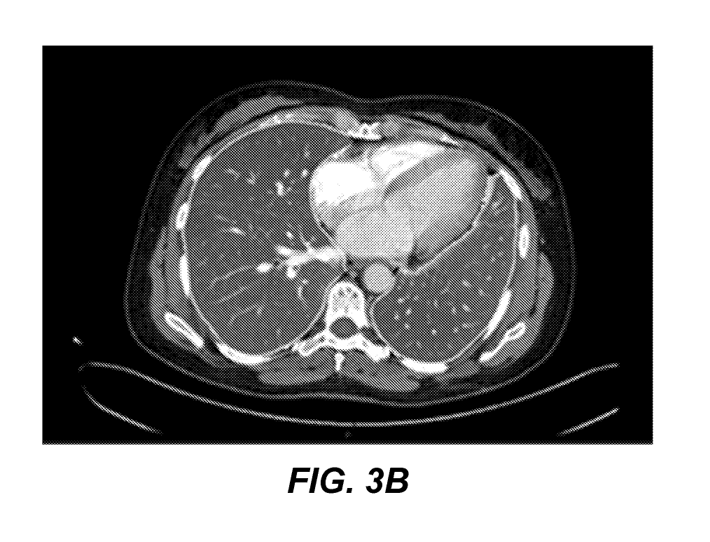

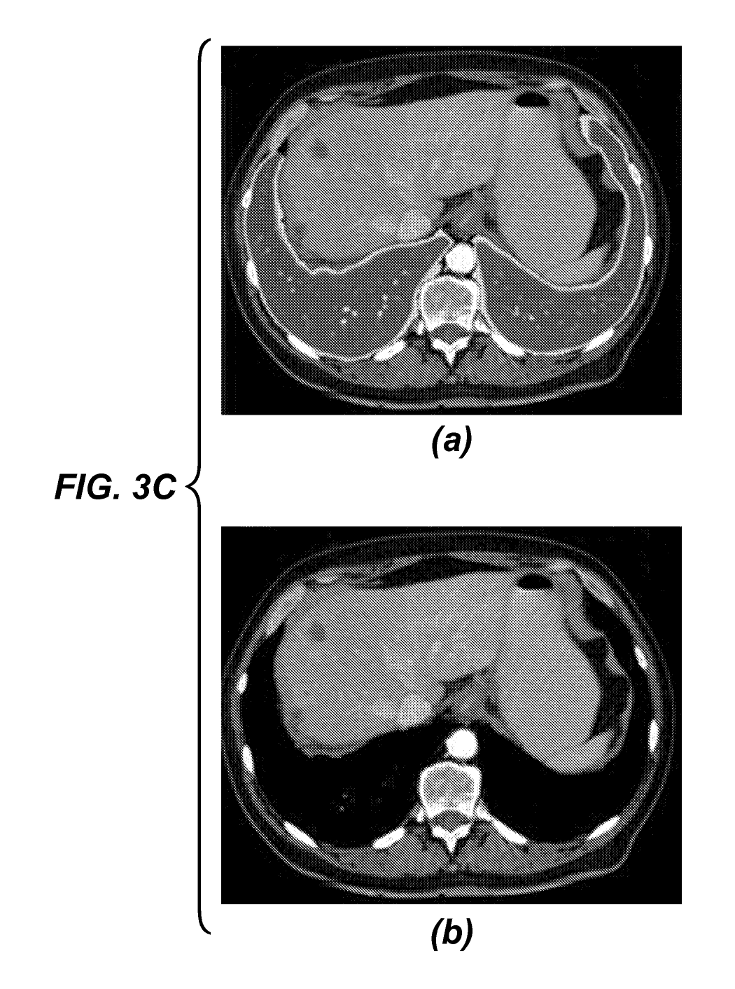

FIGS. 3A-3C show some exemplary, non-limiting screenshots of screens generated according to at least some embodiments of the present invention, showing images generated as described herein. As shown, FIG. 3A shows an image with a coronal view with three windows (two masks): lung, bone, and abdomen (background). FIG. 3B shows an image of an axial view with two windows (one mask): lung and abdomen (background). FIG. 3C shows an axial view with two windows, lung and abdomen (a), compared to the same slice with only abdomen windowing (b); clearly more details are available for view in the (a) image.

It will be appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable sub-combination. It will also be appreciated by persons skilled in the art that the present invention is not limited by what has been particularly shown and described hereinabove. Rather the scope of the invention is defined only by the claims which follow.

What is claimed is:

1. A method for generating a single two-dimensional image of a portion of a body of a subject, comprising:
collecting a radiological scan from an imaging device to form image data;
obtaining at least one anatomically significant mask for the image data;
determining a portion of the image data as background;
applying a plurality of windows to the image data determined according to the anatomically significant mask and according to the background to determine display values of the image data; and
generating a generated display image from the display values.

2. The method of claim 1, further comprising displaying the generated display image.

3. The method of claim 1, wherein the at least one anatomically significant mask comprises a plurality of anatomically significant masks.

4. The method of any of claim 1, wherein each anatomically significant mask corresponds to image data relating to a specific organ.

5. The method of any of claim 1, wherein each anatomically significant mask is determined according to segmentation.

6. The method of claim 5, wherein the segmentation is performed automatically.

7. The method of claim 5, wherein the segmentation is performed semi-automatically.

8. The method of claim 5, wherein the segmentation is performed manually.

9. The method of any of claim 1, wherein each window maps a specific group of values of the image data to a group of display values of the generated display image.

10. The method of claim 9, wherein each window piecewise-linearly maps a specific range of values of the image data to a range of display values of the generated display image.

11. The method of claim 1, further comprising providing at least one preset piecewise-linear window.

12. The method of claim 11, wherein the providing comprises providing one or more preset piecewise-linear windows for CT or x-ray scans and wherein the one or more windows piecewise-linearly map the specific range of values of the image data to the range of display values.

13. The method of claim 1, wherein obtaining the masks further comprises selecting masks according to one or more of configuration, user selection, hard coded rules or through automatic computation.

14. The method of claim 13, wherein the selecting the masks comprises selecting the masks from a pre-existing plurality of masks.

15. The method of claim 1, further comprising assigning windowing parameters to each one of obtained masks according to one or more of configuration, user selection, hard coded rules or through automatic computation.

16. The method of claim 15, further comprising adjusting at least one window by a user.

17. The method of claim 15, further comprising generating the windowing parameters automatically.

18. The method of claim 17, wherein the generating is performed for image data obtained from an imaging device selected from the group consisting of PET (positron emission tomography) scanner, an MRI (magnetic resonance imaging) scanner and an US (ultrasound) scanner.

19. The method of claim 1, wherein the determining the background comprises determining any image data not belonging to any obtained or selected organ mask to be the background, and wherein the windowing for the background comprises a background windowing.

20. The method of claim 1, wherein all of the windows are applied simultaneously.

21. The method of claim 1, wherein the radiological scan comprises a three dimensional scan or a two dimensional scan.

22. The method of claim 21, wherein the image data comprises three dimensional data and wherein the generating the generated display image comprises determining a two dimensional slice of the three dimensional data.

23. The method of claim 21, wherein the image data comprises three dimensional data, the method further comprising, before the obtaining the mask, determining a two dimensional slice of the three dimensional data.

24. The method of claim 1, wherein the radiological scan is selected from the group consisting of PET (positron emission tomography) scanner, a CT (computerized tomography) scanner, an MRI (magnetic resonance imaging) scanner, an x-ray scanner and an US (ultrasound) scanner.

25. The method of claim 1, wherein the applying the plurality of windows comprises applying linear or non-linear window parameters.

26. The method of claim 1, wherein each organ is assigned to a separate mask, or a plurality of organs is assigned the same mask.

27. The method of claim 1, wherein at least one organ is assigned to the background.

28. The method of claim 1, further comprising interpolating the image data, and the interpolating is performed after applying the plurality of windows.

29. The method of claim 1, further comprising interpolating the image data, and the interpolating is performed before applying the plurality of windows.

30. The method of claim 29, further comprising interpolating the masks before applying the plurality of windows.
